(19) United States
(12) Patent Application Publication
(10) Pub. No.: US 2025/0351758 A1
(43) Pub. Date: Nov. 20, 2025

(54) AGRICULTURAL WORKING MACHINE

(71) Applicant: Grimme Landmaschinenfabrik GmbH & Co. KG, Damme (DE)

(72) Inventors: Ansgar Lange gen. Detert, Melle (DE); Michael Böging, Goldenstedt/Lutten (DE); Kai Dernjac, Vechta (DE); Michael Dreishing, Neuenkirchen-Vörden (DE)

(21) Appl. No.: 19/204,920

(22) Filed: May 12, 2025

(30) Foreign Application Priority Data
May 14, 2024 (DE) 202024102482.6

(51) Int. Cl. A01B 33/16; A01B 33/02

(52) U.S. Cl. CPC A01B 33/16; A01B 33/021

(57) ABSTRACT

An agricultural working machine is provided with a shaft having with at least one tool, the rotation axis of which extends in operation at an angle to the direction of travel and at least substantially parallel to the ground. A housing is arranged on a frame of the working machine, which housing is arranged at least in sections above the shaft and has an inner wall delimiting a channel between the shaft and the housing. The inner wall of the housing is at least formed by a plurality of segments arranged next to one another as viewed in the direction of travel.

### CROSS REFERENCE

This application claims priority to German Patent Application No. 20 2024 102482.6, filed May 14, 2024, the entirety of which is hereby incorporated by reference.

### FIELD OF THE INVENTION

The present invention relates to an agricultural working machine.

### BACKGROUND OF THE INVENTION

EP 0 954 953 B1 discloses an agricultural working machine in the form of a soil tillage machine which has a rotor, i.e., a shaft with a tool, whose rotation axis extends at an angle to the direction of travel and at least substantially parallel to the ground during operation. The rotor is partially enclosed by a housing arranged on a frame of the working machine, which is arranged at least in sections above the shaft of the rotor. The housing comprises an inner wall that forms a channel between the shaft and housing or limits it upwards. If the housing is damaged by stones, for example, it must be replaced at great expense and replaced completely.

### BRIEF SUMMARY OF THE INVENTION

The object of the present invention is to be able to use a soil tillage machine according to the invention in a more material-friendly manner.

According to the invention, an agricultural working machine is characterized in that an inner wall of the housing delimiting the channel between the shaft and the housing is at least formed by a plurality of segments arranged next to one another as viewed in the direction of travel. Accordingly, each of these segments has a side running in the direction of the planar extension of the segments, which represents an inner boundary of the channel.

The invention is based on the finding that, due to the materials being conveyed at least partially around the rotation axis of the shaft in the circumferential direction, the significant wear also occurs mainly in the circumferential direction around the shaft on the inner wall of the housing. An inner wall in the sense of the invention is a wall that delimits the channel inwards, i.e., from the housing in the direction of the shaft or rotation axis. In single-skin housings, the inner wall is also an outer wall. By segmenting the housing in the circumferential direction, individual segments of the housing that are subject to excessive wear can be replaced, while areas that are less subject to wear can continue to be used. The segments are detachably attached to each other. In this respect, the use of a segmented housing, which has several segments across the width of the housing or along the length of the shaft, is more material-friendly.

The segments have a sheet-like, in particular substantially strip-shaped and/or identical design. The strip-shaped design of the segments, i.e., a greater extension of the segment in the longitudinal direction (parallel to the direction of travel or running around the shaft) than in the transverse direction and a thickness of larger areas of the segment that is negligible compared to the length of the segments, also results in a material-friendly and in particular production-friendly design of the working machine. Thanks to the identical parts approach of the housing segments, it can be manufactured at a lower cost and repaired more easily.

In particular the segments are curved in the direction of their longitudinal extension in order to simulate a corresponding channel around the shaft.

The housing is arranged above the shaft in such a way that, viewed in the longitudinal direction of the rotation axis and with respect to a perpendicular on the shaft or a corresponding surface along the same, the housing is formed within an angle of at least +/−30° around the rotation axis, in particular over a swivel angle of 90° to 180°. The channel is the area formed between the shaft and the housing, wherein tools of the shaft passing through the channel during operation are not taken into account.

Advantageously, with respect to the direction of travel, the housing has a front and a rear housing part with respective inner wall parts which each extend along the shaft and of which one is formed by the several segments arranged next to one another and of which the other is also at least formed by several further segments arranged next to one another as viewed in the direction of travel. In particular the inner wall parts are formed entirely by the segments of the front and rear housing parts, which are particularly identical. The identical parts approach therefore applies to the entire inner wall, even if it is divided into two parts. In a top view of the housing, the housing thus has two rows of segments formed next to each other, which form the inner wall and thus the upper boundary of the channel through which the processed soil is transported by the soil tillage machine.

By using an elastomeric material for the segments, which are at least predominantly formed by this material, housing shapes can be suitably reproduced without the use of complex bending or edging processes as required in the prior art. The design is at least predominantly made of an elastomeric material if the elastomeric material forms the largest part of the inner wall, alternatively or additionally if the elastomeric material forms at least more than 50% of the volume of the inner wall.

The segments are longer in the direction around the shaft than they are wide (in the axial direction of the shaft), which takes the aforementioned wear process into account.

To stabilize the segments, they can have at least one longitudinal web, running preferably along a longitudinal edge, which can also be used to attach the segments to each other, to a frame and/or to a housing frame.

In particular the segments have a recess on at least one longitudinal side in such a way that segments arranged next to one another are partially overlapping, so that on the one hand earth is prevented from being removed from the channel via this sealing area of adjacent segments during operation and on the other hand an improved fixing of the segments to one another is achieved. For the arrangement of identical segments next to each other, longitudinal sides of the same segment facing away from each other have correspondingly complementary recesses, for example, in the form of a tongue and groove design or other types of radial and/or axial interlocking of the segments.

In addition to the segments, according to a further embodiment of the invention, compensating pieces can be provided which advantageously almost completely surround the rotor shaft like the segments in a ground flow-optimized angular range and which can additionally be attached to the segments, in particular as a lateral closure or lateral closures, in order to widen the housing. These compensating elements can have at least approximately the same dimensions as the segments themselves. In particular, however, the inner wall of the housing is designed without the compensating pieces.

On their side facing away from the shaft, the segments have fastening means for fastening the respective segment to the frame, a housing frame or also for fastening to a further segment, in accordance with an advantageous further development of the invention. These can be formed in particular by the longitudinal web or webs. Particularly when using elastomeric materials that are used in a casting or injection molding process, significantly more diverse fastening shapes and contours can be created, which can be designed for optimal material use.

To stiffen at least one of the segments and/or the housing, at least one cross member is provided to which the segments can be attached. In particular this extends completely along the shaft parallel to its longitudinal or rotation axis.

In particular a plurality of segments, preferably all segments of a housing part, are arranged on one or more cross members, which are then arranged one behind the other in the direction of travel. For example, recesses in the side bars can be provided for this purpose, through which a cross member can be passed.

Similarly, a side member can also be provided to secure the individual cross members against each other or to stiffen the housing part in the longitudinal direction.

The segments can be quickly and easily arranged next to each other by threading them on via receptacles in the longitudinal bars in the form of recesses in the material, allowing them to be replaced individually if necessary. It goes without saying that the cross members can be detached from the working machine on at least one side for this purpose.

In particular via such cross and side members and their effect on the segments, these can have a plurality of operating states with different radii of curvature, i.e., different distances from the rotation axis of the shaft. It is understood that this does not have to be a fixed radius for an operating condition, but that the distance can vary over the circumferential angle around the rotation axis of the shaft. The distance here is the distance from the rotation axis to the inner surface of the respective segment, viewed along a circumference and in the direction of the rotation axis.

Advantageously, an actuating device is provided via which the position and/or the radius of curvature of the inner wall can be changed in relation to the shaft or the rotation axis. In particular this is an actuating device which has an actuator which acts on a transverse or side member or another part of the housing frame and changes the position of the housing frame so that the segments arranged on the frame must also change their position.

In particular the actuating device can have a rear actuator which acts on a rear housing part and adjusts its rear edge in height and/or along the direction of travel, so that the segments are at different distances from the rotation axis of the shaft and can therefore be moved into different operating positions.

### BRIEF DESCRIPTION OF THE DRAWINGS

Reference is now made more particularly to the drawings, which illustrate the best presently known mode of carrying out the invention and wherein similar reference char-acters indicate the same parts throughout the views.

FIG. 1 shows an isometric view of a subject matter according to an example embodiment of the invention.

FIG. 2 shows a part of the subject matter according to FIG. 1.

FIG. 3 shows a detailed view of a housing part of a subject matter according to an example embodiment of the invention.

FIG. 4 shows a further detailed view of a subject matter according to an example embodiment of the invention.

FIG. 5 shows the subject matter according to FIG. 2 in a partially broken view.

FIG. 6 shows the subject matter according to FIG. 2 in two different operating positions.

FIG. 7 shows a further partial view of the subject matter according to FIG. 1.

FIG. 8 shows a further embodiment of a subject matter according to an example embodiment of the invention in a view according to FIG. 7.

FIG. 9 shows a schematic illustration of another subject matter according to an example embodiment of the invention.

FIG. 10 shows a schematic illustration of another subject matter according to an example embodiment of the invention.

### DETAILED DESCRIPTION OF THE DRAWINGS

Individual technical features of the embodiment examples described below can also be combined with embodiment examples described above and the features of the independent claim and any further claims to form objects according to the invention. Where appropriate, identical reference numbers are assigned to elements that have at least partially the same function.

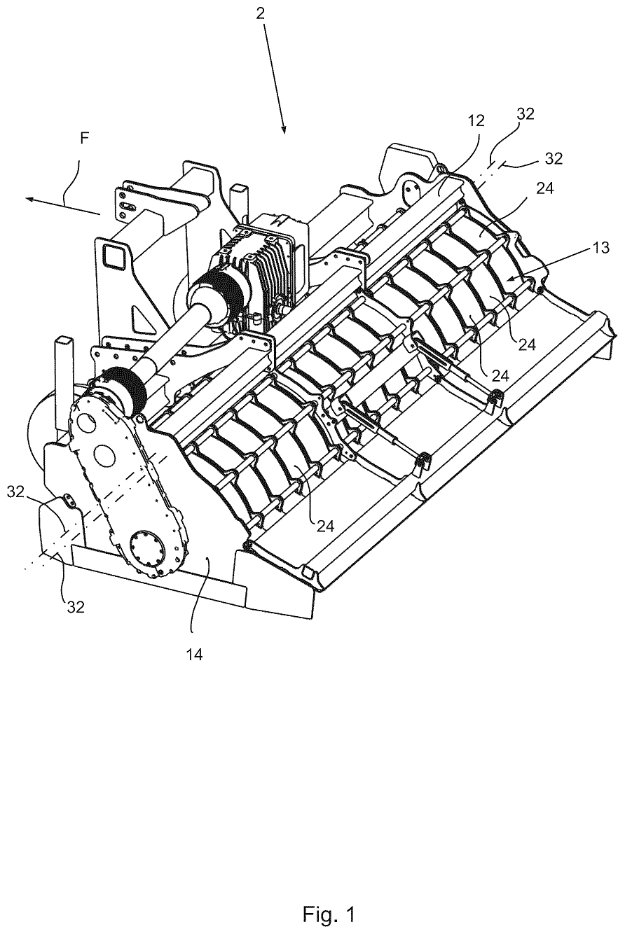

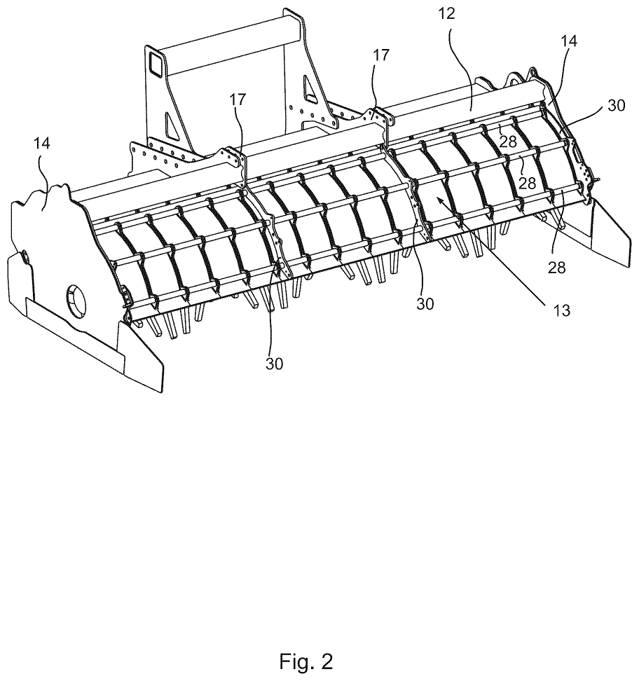

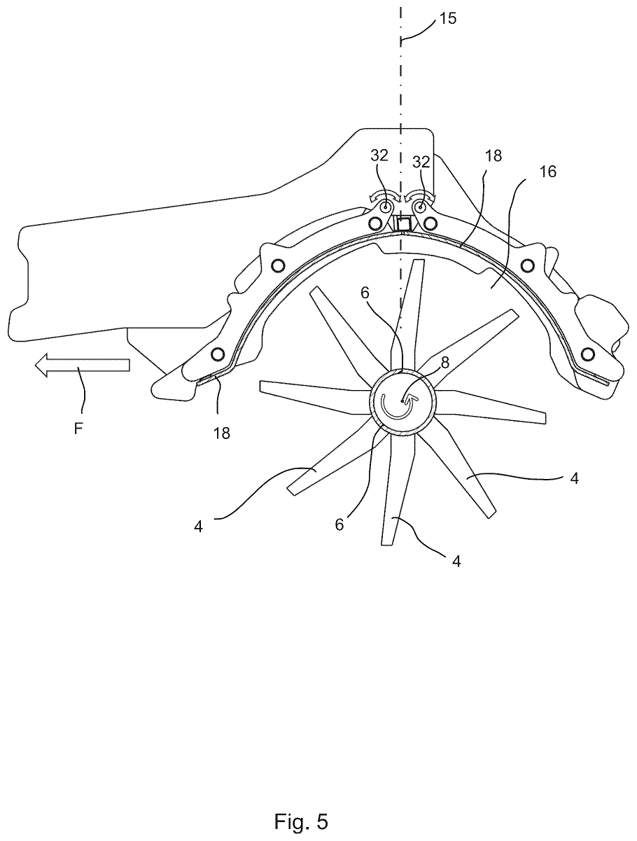

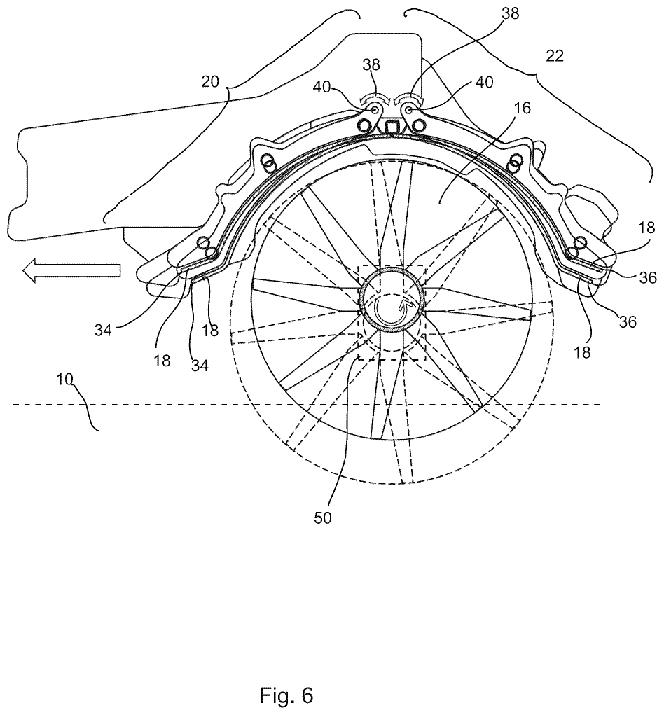

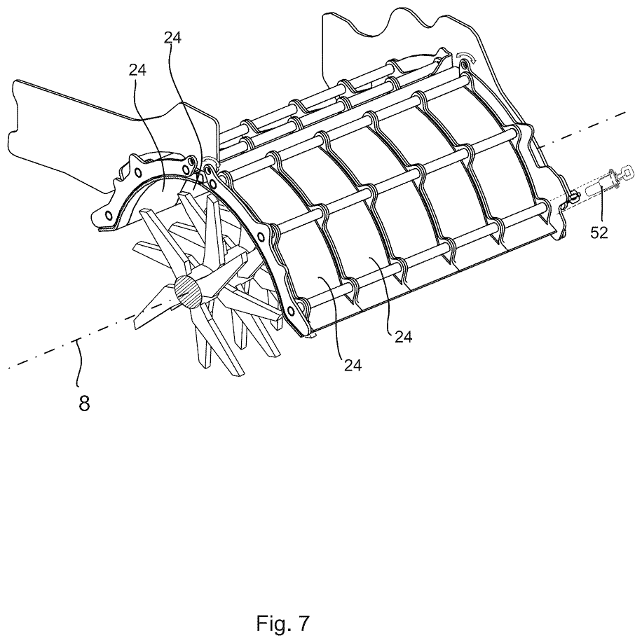

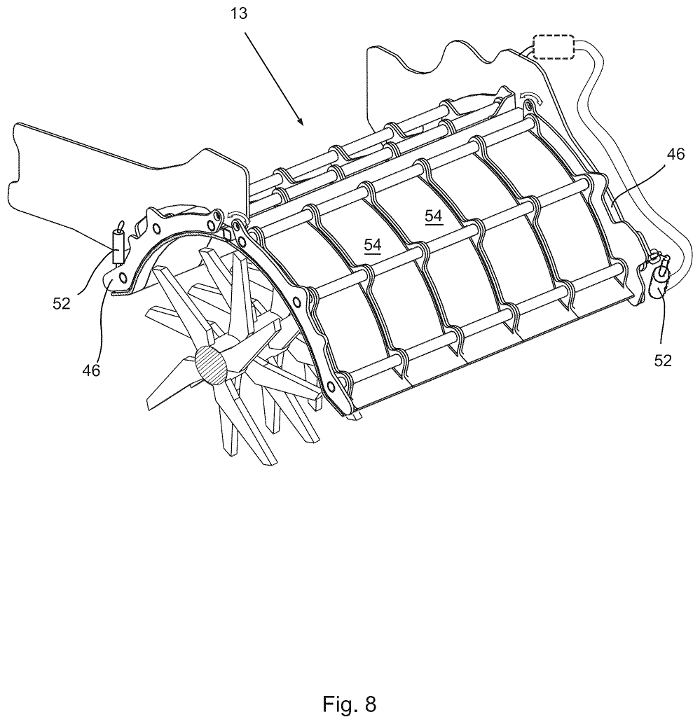

In the present case, an agricultural working machine is a soil tillage machine 2 designed as a soil tiller (FIG. 1). The soil tillage machine 2 has a shaft 6 provided with a plurality of tools 4, whose rotation axis 8 (see FIGS. 5 and 7) extends at an angle to the direction of travel F during operation. In the embodiment example, the rotation axis 8 runs parallel to the ground 10 (FIG. 6). The soil tillage machine 2 further comprises a housing 13 (FIGS. 2 and 8) held on a frame 12, which is arranged over a circumferential angle of almost 180° (FIG. 5) around the shaft 6 and its rotation axis 8.

The housing is arranged at a swivel angle of almost +/−90° above the rotation axis and thus above the shaft in relation to a vertical line 15, which runs through the rotation axis 8 (FIG. 5). A channel 16 is formed between shaft 6 and inner wall parts 18 of the front and rear housing parts 20, 22 of the housing, in and through which the soil or earth is conveyed.

The front housing part 20 and the rear housing part 22 are movably arranged and can swivel about swivel axes 32, which are arranged above the shaft 6 (FIG. 6). For this purpose, the housing parts 20, 22 are mounted so that they can swivel via side members 30 in side plates 14 and center plates 17 of the frame 12. The housing parts 20, 22 extend in particular completely over the length of the shaft 6 and can assume the two operating positions shown one above the other in FIG. 6 as well as additional intermediate positions not shown. Accordingly, FIG. 6 shows two inner wall parts 18 of the front and rear housing parts. In the two operating positions shown, the two fixed adjustable operating positions of the front housing part 20 differ in that in a swung-open, upper operating position, a front edge 34 is further forward and higher with respect to the ground 10 than the front edge 34 in the swiveled-in, lower position. The same applies to the rear edge 36 of the rear housing part 22. The mobility of the front and rear housing parts 20, 22 is indicated by double arrows 38 in the area of swivel bearings 40.

In general, the housing of the soil tillage machine 2 is formed by a front and rear housing part 20 and 22, wherein the inner wall of the housing is formed by the two (front and rear) inner wall parts 18.

For their part, the inner wall parts 18 and thus also the inner wall of the housing are formed according to the invention in each case by a plurality of identical segments 24 arranged next to one another when viewed in the direction of travel. The segments 24 are sheet-like, in particular strip-shaped, and are longer than they are wide when viewed parallel to the direction of travel or in the circumferential direction around the shaft. This takes account of the fact that the relevant movement of the earth and thus the wear also takes place in the direction of travel and in the circumferential direction around the shaft 6. Areas that are particularly susceptible to wear, depending on the tool configuration, can thus be easily replaced without having to replace the entire housing wall or inner wall of the housing 13. Both the front and rear housing parts 20, 22 are made up of segments 24. In addition to the segments 24, compensating pieces can be provided as described above, which advantageously almost completely surround the shaft 6 in an angle range optimized for earth flow.

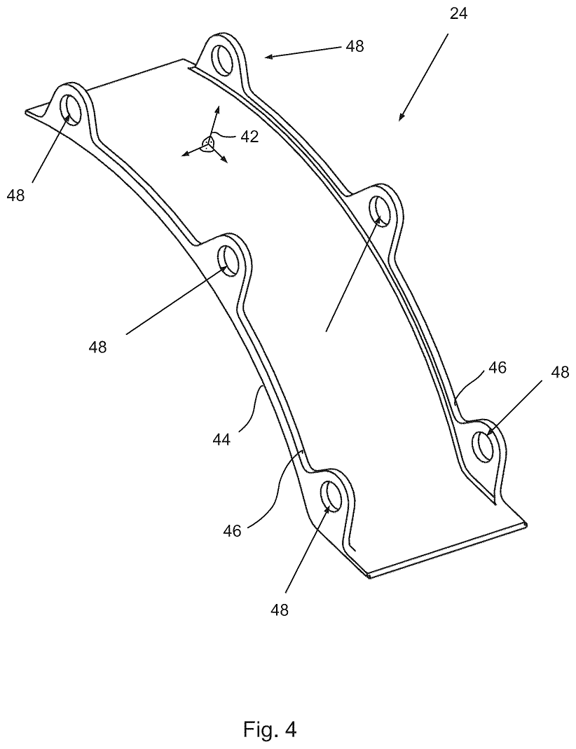

The segments 24 are formed entirely by an elastomeric material with a Shore hardness A of between 75 and 95 and can oscillate or vibrate accordingly, in particular in a direction parallel to the vertical 42 (FIG. 4).

The segments 24 have longitudinal webs 46 running along their longitudinal edges 44, which stiffen the segments 24. At the same time, the longitudinal webs 46 form receptacles 48 through thickened, widened areas, via which the segments 24 are attached to the cross members 28. These in turn are mounted in the side members 30, wherein one or more cross members 28 can be mounted so as to be relatively movable with respect to the side members 30 via elongated holes not shown. The cross and side members 28, 30 each form a housing part frame, which can swivel relative to the frame 12, allowing the housing parts and thus also the segments 24 to assume different operating positions.

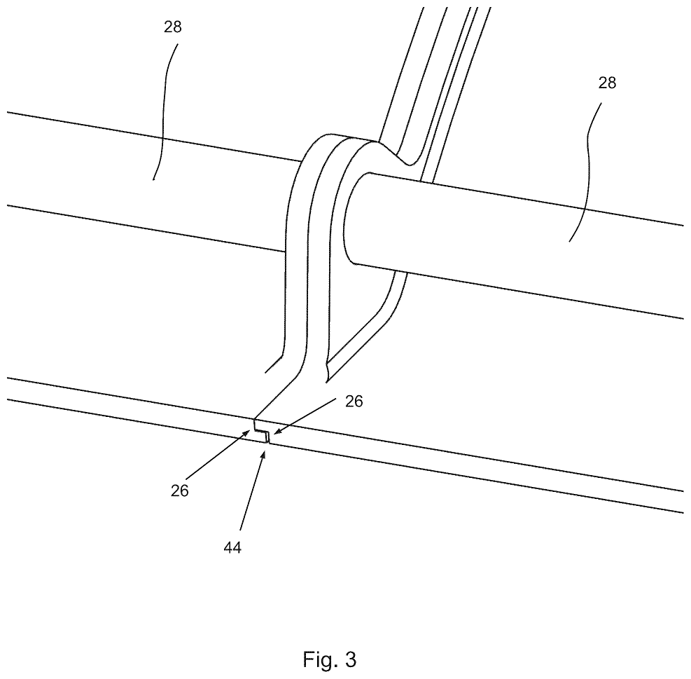

For better and more sealing contact of the segments, these have recesses or shoulders 26 along the longitudinal edges 44, which have complementary shapes on the sides facing each other (FIG. 3) and via which a seal is created in the contact with each other, due to which the earth is held better in the channel 16. Segments 24 arranged next to each other are therefore partially overlapping.

The receptacles 48 provide fastening means that can be used for fastening to the housing frame or also for fastening to each other. Corresponding to the different operating states of the rear and front housing parts 20, 22, the segments 24 also have correspondingly different operating states with different distances of the inner wall from the rotation axis 8.

In addition, the soil tillage machine 2 is provided with a shaft actuating device 50, shown only in dashed lines and arranged at the end of the shaft 6, by means of which the shaft can be moved into the position shown in dashed lines in FIG. 6 and fixed there. The shaft actuating device 50 is arranged on the frame 12 of the soil tillage machine 2 so that it can be adjusted in height.

Both the front and the rear housing parts 20, 22 are adjustable via a front and a rear actuator 52, namely adjustable about the respective swivel axis 32, which in FIG. 5, for example, runs perpendicular to the plane of the figure in each case. For example, the actuator 52 is a hydraulic cylinder that is fixed on the frame side and attached to a side member 46 (FIG. 8) or a simple mechanical fixing of the housing parts 20, 22 to the frame 12 via a screw means whose length can be varied (FIG. 7).

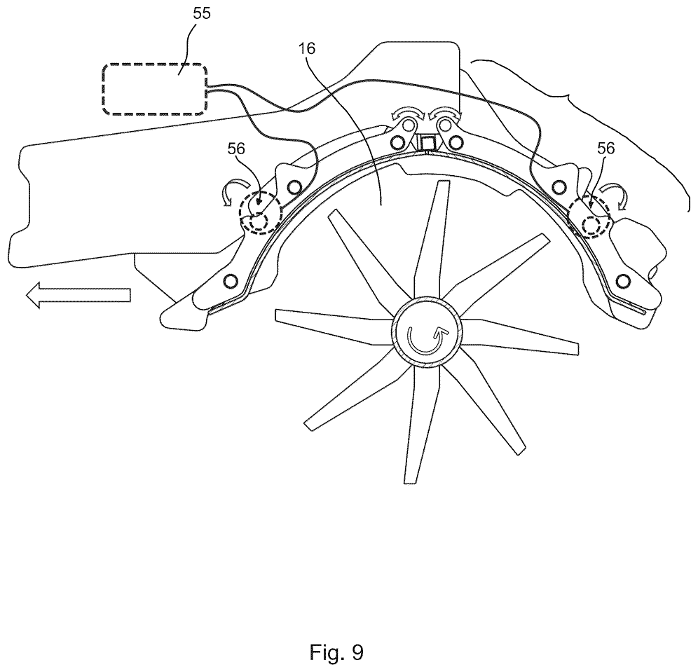

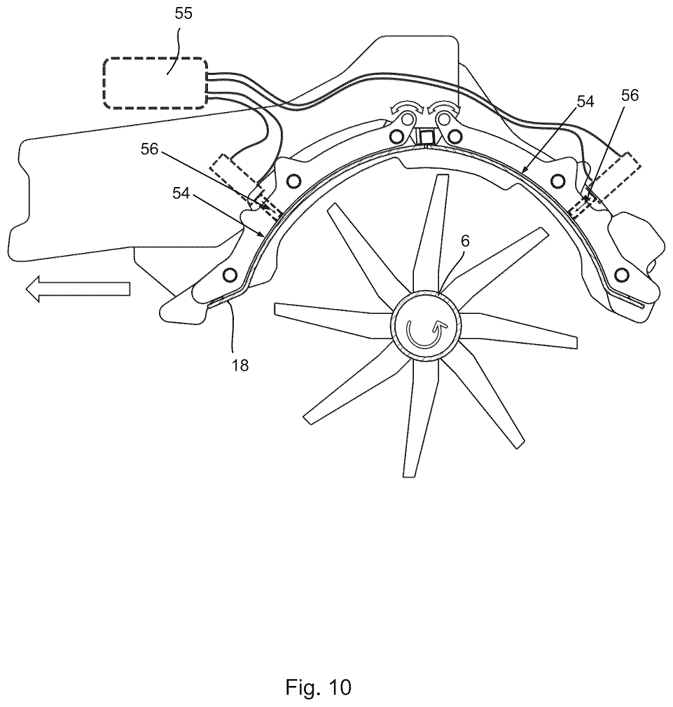

Vibration generators arranged on the frame side transmit vibrations to the outer surfaces 54 via their vibration means 56. As a result, the rotational speeds of vibration means 56 in the form of eccentrically arranged rotating disks or the frequencies of vibration means 56 in the form of longitudinally movable stamps perpendicular to the surface 54 are predetermined, in particular depending on the speed, via a corresponding control device 55, which can be part of the machine control of the working machine (FIGS. 9 and 10).

1. An agricultural working machine comprising:
a shaft provided with at least one tool, a rotation axis of said shaft extending in operation at an angle to a direction of travel (F) and at least substantially parallel to the ground;
a housing arranged on a frame of the working machine, which housing is arranged at least in sections above the shaft and having an inner wall delimiting a channel between the shaft and the housing;
wherein the inner wall of the housing is at least formed by a plurality of segments arranged next to one another as viewed in the direction of travel (F).

2. The working machine according to claim 1, wherein the segments are sheet-like and/or identical.

3. The working machine according to claim 1, wherein the housing has, with respect to the direction of travel (F), a front housing part and a rear housing part with respective inner wall parts which each extend along the shaft and of which one is formed by the several segments arranged next to one another and of which the other is also at least formed by several further segments arranged next to one another as viewed in the direction of travel (F).

4. The working machine according to claim 3, wherein the segments of the front housing part and rear housing part are identical.

5. The working machine according to claim 1, wherein the segments are formed at least predominantly by an elastomeric material.

6. The working machine according to claim 1, wherein the segments are longer than wide when viewed parallel to the direction of travel (F).

7. The working machine according to claim 1, wherein the segments have at least one longitudinal web.

8. The working machine according to claim 1, wherein the segments have a recess on at least one longitudinal side such that segments arranged next to one another are arranged partially overlapping.

9. The working machine according to claim 1, wherein the segments have fastening means on a side facing away from the shaft for fastening to the frame, a housing frame, or to each other.

10. The working machine according to claim 1, wherein at least one cross member is provided to stiffen at least one of the segments.

11. The working machine according to claim 1, wherein the segments have a plurality of operating states with different radii of curvature.

12. The working machine according to claim 1, further comprising an actuating device adapted to change a position and/or radius of curvature of the inner wall in relation to the shaft.

13. The working machine according to claim 12, wherein at least one rear actuator of the actuating device is assigned to the rear housing part, via which a rear edge of the rear housing part can be adjusted in height and/or along the direction of travel (F).

14. The working machine according to claim 7, wherein the at least one longitudinal web extends along a longitudinal edge.
